(19) United States
(12) Patent Application Publication
(10) Pub. No.: US 2020/0374613 A1
(43) Pub. Date: Nov. 26, 2020

(54) LOUDSPEAKER AND EARPHONES

(71) Applicant: Panasonic Intellectual Property Management Co., Ltd., Osaka-shi, Osaka (JP)

(72) Inventors: Shuji Saiki, Nara (JP); Yuji Matsuo, Okayama (JP); Kazuyuki Kosuda, Okayama (JP); Yuichi Kobayashi, Okayama (JP); Yasuhiro Makino, Okayama (JP)

(73) Assignee: Panasonic Intellectual Property Management Co., Ltd., Osaka-shi, Osaka (JP)

(21) Appl. No.: 16/635,326

(22) PCT Filed: Aug. 1, 2018
(86) PCT No.: PCT/JP2018/028854

§ 371 Date: Jan. 30, 2020

(30) Foreign Application Priority Data
Aug. 8, 2017 (JP) 2017-153404

(51) Int. Cl. H04R 1/10; H04R 9/02

(52) U.S. Cl. CPC H04R 1/10; H04R 9/027

(57) ABSTRACT

A loudspeaker including: a magnetic circuit, a voice coil, a vibration plate, a housing, and a magnetic fluid disposed between a plate and the voice coil in a magnetic gap. The magnetic circuit includes a first flow path which passes from a vibration plate side to a rear surface. The housing includes a second flow path which extends the first flow path, and a third flow path which passes through from the vibration plate side to the second flow path. A proportion of a second area to a first area matches with a proportion of an outer area to an inner area, which is an area of the vibration plate corresponding to an inner side with respect to the voice coil.

### TECHNICAL FIELD

This disclosure relates to a loudspeaker including a magnetic fluid, and earphones, hearing aids, and portable terminal apparatuses including the loudspeaker.

### BACKGROUND ART

PTL 1 discloses a conventional loudspeaker including a magnetic fluid. In a magnetic gap included in a magnetic circuit, the magnetic fluid is disposed between the magnetic circuit and a voice coil whose one end is inserted into the magnetic gap. Thus, the vibration of the voice coil under low friction drag is stabilized in such a conventional loudspeaker by disposing the magnetic fluid between the voice coil and the magnetic circuit.

### CITATION LIST

### Patent Literature

### [PTL 1] Japanese Unexamined Patent Application Publication No. 2013-157735

### SUMMARY OF INVENTION

### Technical Problem

In the conventional loudspeaker including a magnetic fluid, the magnetic fluid is scattered by the wind pressure caused by the vibration of the vibration plate when sounds are produced, and thereby the function of the voice coil to stabilize the vibration is reduced. This results in an abnormal operation of the loudspeaker or a reduction in reliability and life thereof.

An object of this disclosure is to provide a loudspeaker which reduces influences of wind pressure on the magnetic fluid, and earphones including the loudspeaker.

### Solution to Problem

The loudspeaker according to one aspect of this disclosure includes a magnetic circuit; a voice coil having one end disposed inside a magnetic gap formed in the magnetic circuit; a vibration plate to which the other end of the voice coil is fixed; a housing which is in a shape of a bottomed tube, accommodates the magnetic circuit, and holds the vibration plate; and a magnetic fluid disposed between the magnetic circuit and the voice coil inside the magnetic gap, wherein the magnetic circuit includes a first flow path disposed on an inner side with respect to the voice coil to pass from a vibration plate side of the magnetic circuit to a rear surface of the magnetic circuit, air passing through the first flow path, the housing includes a second flow path which extends the first flow path to an outer side of a bottom surface of the housing; and a third flow path disposed on an outer side with respect to the voice coil to pass from the vibration plate side to the second flow path, and a proportion of a second area to a first area matches with a proportion of an outer area to an inner area, where the first area is an area of an opening of the first flow path and the second area is an area of an opening of the third flow path when seen from a tube axis direction of the voice coil, and the inner area is an area of the vibration plate corresponding to the inner side with respect to the voice coil and the outer area is an area of the vibration plate corresponding to the outer side with respect to the voice coil when seen from the tube axis direction of the voice coil.

### Advantageous Effects of Invention

The loudspeaker according to this disclosure can maintain its performance even after long-term use.

### BRIEF DESCRIPTION OF DRAWINGS

FIG. 1 is a perspective view illustrating an appearance of the loudspeaker according to Embodiment 1.

FIG. 2 is an exploded perspective view illustrating the loudspeaker according to Embodiment 1.

FIG. 3 is a sectional view illustrating the loudspeaker according to Embodiment 1 in FIG. 1 taken along line III-III.

FIG. 4 is a sectional view illustrating the loudspeaker according to Embodiment 1 in FIG. 1 taken along line IV-IV.

FIG. 5 is a plan view illustrating a vibration plate according to Embodiment 1 seen from the front surface side thereof.

FIG. 6 is a plan view illustrating the loudspeaker seen from the front surface side thereof, where the vibration plate according to Embodiment 1 is removed.

FIG. 7 is a diagram schematically illustrating the air flow when the loudspeaker is used.

FIG. 8 is a perspective view illustrating an appearance of the loudspeaker according to Embodiment 2.

FIG. 9 is an exploded perspective view illustrating the loudspeaker according to Embodiment 2.

FIG. 10 is a sectional view illustrating the loudspeaker in FIG. 8 taken along line X-X.

FIG. 11 is a sectional view illustrating the loudspeaker in FIG. 8 taken along line XI-XI.

FIG. 12 is a diagram illustrating a vibration plate according to Embodiment 2 seen from the front surface side.

FIG. 13 is a diagram illustrating the loudspeaker seen from the front surface side thereof, where the vibration plate according to Embodiment 2 is removed.

FIG. 14 is a perspective view illustrating an appearance of an earphone including the loudspeaker according to any one of Embodiments 1 and 2.

FIG. 15 is an exploded perspective view illustrating the earphone including the loudspeaker according to any one of Embodiments 1 and 2.

### DESCRIPTION OF EMBODIMENTS

### Knowledge Underlying this Disclosure

The present inventors have found that the following problems arise in the conventional loudspeaker including a magnetic fluid.

The conventional loudspeaker disclosed in PTL 1 uses a magnetic fluid having a high viscosity to exert resistance against the wind pressure caused by the vibration plate, thereby preventing the scattering of the magnetic fluid. However, an increase in viscosity of the magnetic fluid results in an increased resistance against the vibration of the voice coil, which changes the output sound pressure.

An audio signal input to the voice coil generates Joule heat. For this reason, even if the magnetic fluid having high viscosity is used, the viscosity is reduced by the Joule heat from the voice coil to increase the possibility of scattering of the magnetic fluid by the wind pressure.

Such knowledge is obtained that the conventional loudspeakers including a magnetic fluid have difficulties in preventing scattering of the magnetic fluid and stably maintaining the performance of the loudspeaker.

Based on the knowledge above, the inventor, who has conducted extensive research, has found a technique of preventing scattering of a magnetic fluid by using a structure in which wind pressures are applied to a magnetic fluid from two different directions on a straight line, and cancelling the two wind pressures through balancing of the two wind pressures.

In other words, the loudspeaker according to one aspect of this disclosure includes a magnetic circuit; a voice coil having one end disposed inside a magnetic gap formed in the magnetic circuit; a vibration plate to which the other end of the voice coil is fixed; a housing which is in a shape of a bottomed tube, accommodates the magnetic circuit, and holds the vibration plate; and a magnetic fluid disposed between the magnetic circuit and the voice coil inside the magnetic gap. The magnetic circuit includes a first flow path disposed on an inner side with respect to the voice coil to pass from a vibration plate side of the magnetic circuit to a rear surface of the magnetic circuit. The housing includes a second flow path which extends the first flow path to an outer side of a bottom surface of the housing, and a third flow path disposed on an outer side with respect to the voice coil to pass from the vibration plate side to the second flow path. The proportion of a second area to a first area matches with the proportion of an outer area to an inner area where the first area is a cross-sectional area of the first flow path and the second area is a cross-sectional area of the third flow path, and the inner area is an area of the vibration plate corresponding to the inner side with respect to the voice coil and the outer area is an area of the vibration plate corresponding to the outer side with respect to the voice coil when seen from the tube axis direction of the voice coil.

In such a configuration, the wind pressure applied to the magnetic fluid from the side of the vibration plate and the wind pressure applied to the magnetic fluid from the side opposite to the vibration plate can be balanced to prevent the scattering of the magnetic fluid. The term “match” used in the description and Claims does not mean only complete matching, rather is used as a meaning that a certain error is tolerated in the range preventing the scattering of the magnetic fluid.

Moreover, the flow rate of the air passing through the first flow path and the second flow path is equal or substantially equal to the flow rate of the air passing through the third flow path. For this reason, the second flow path can be connected to the third flow path, and the air can pass to the outside only at the opening end of the second flow path, resulting a size reduction in loudspeaker.

Moreover, the housing may be in a shape of a bottomed cylinder, and the third flow path includes a side wall flow path portion disposed in a side wall of the housing and having a cross-section in a shape of a sector.

In such a configuration, even when the thickness of the housing is reduced to reduce the size of the loudspeaker, a reduction in structural strength caused by the side wall flow path portion can be prevented, and the loudspeaker can have improved durability against fall or the like.

Moreover, the side wall flow path portion, which is disposed in the side wall of the housing as part of the third flow path, may be formed of a groove formed in the housing facing a side of the magnetic circuit, and an outer circumferential surface of the magnetic circuit which covers the groove.

By forming the side wall flow path portion in the form of a groove and the magnetic circuit into a hole, the thickness of the side wall of the housing can be reduced, contributing to a size reduction in the entire loudspeaker.

Moreover, the housing may include a side wall member which is tubular, a bottom plate disposed at one end of the side wall member, and a spacer disposed between the bottom plate and the magnetic circuit. The side flow path portion, which is disposed at a bottom of the housing as part of the third flow path, may be formed of a bottom surface of the magnetic circuit, the bottom plate disposed facing the bottom surface, and a slit disposed in the spacer.

In such a configuration, the second flow path, which is in communication with the first flow path, and the third flow path can be readily connected with a simple structure. Moreover, since part of the side flow path portion is formed of the magnetic circuit, such a configuration can contribute to a size reduction in housing.

Moreover, the loudspeaker may include a stopper which is attached to the magnetic circuit on the vibration plate side of the magnetic circuit to regulate displacement of the vibration plate toward the magnetic circuit, and the stopper may include a fourth flow path which extends the first flow path to the vibration plate side, and has an opening having an area larger than the first area of the first flow path.

In such a configuration, a stopper which does not inhibit the air circulation in the first flow path can be attached to regulate unexpected displacement of the vibration plate.

Moreover, the magnetic circuit may include a magnet having a magnet path which is part of the first flow path, a plate having a plate path which is part of the first flow path, and a yoke having a yoke path which is part of the first flow path, and the cross-sectional area of the magnet path may be smaller than the cross-sectional area of the plate path and the cross-sectional area of the yoke path.

In such a configuration, the magnetic circuit can be readily assembled, and the air circulation in the first flow path can be preferably maintained. The first area as the cross-sectional area of the first flow path corresponds to the cross-sectional area of the magnet path.

Moreover, the loudspeaker may include a net which covers an opening end of a rear surface of the second flow path opposite to the vibration plate with respect to the housing.

In such a configuration, the sound pressure frequency properties of the loudspeaker can be adjusted with the opening area of a single net.

Moreover, the earphone according to one aspect of this disclosure includes the loudspeaker described above.

According to this aspect, the same effect as that of the loudspeaker according to one aspect of this disclosure can be obtained.

### Embodiment 1

The loudspeaker according to one aspect of this disclosure will now be specifically described with reference to the drawings.

The embodiments described below all illustrate specific examples of this disclosure. Numeric values, shapes, materials, components, arrangement positions and connection forms of the components, processings, order of processings and the like described in the following embodiments are exemplary, and should not be construed as limitative to this disclosure. Moreover, among the components of the embodiments below, the components not described in an independent claim representing the most superordinate concept of the present disclosure will be described as arbitrary components.

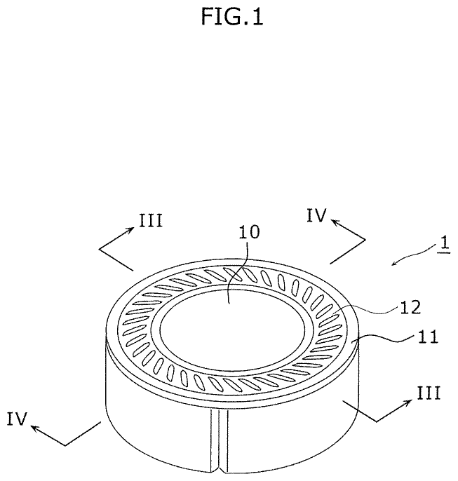

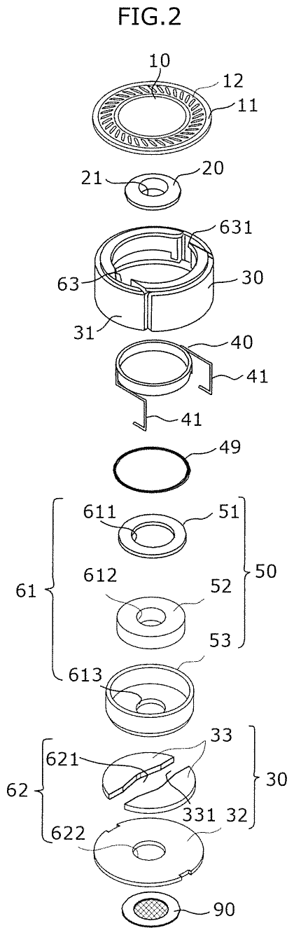

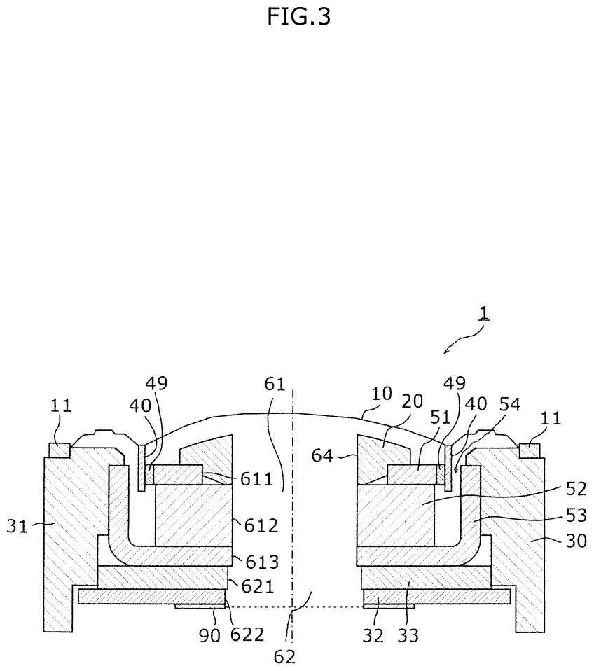

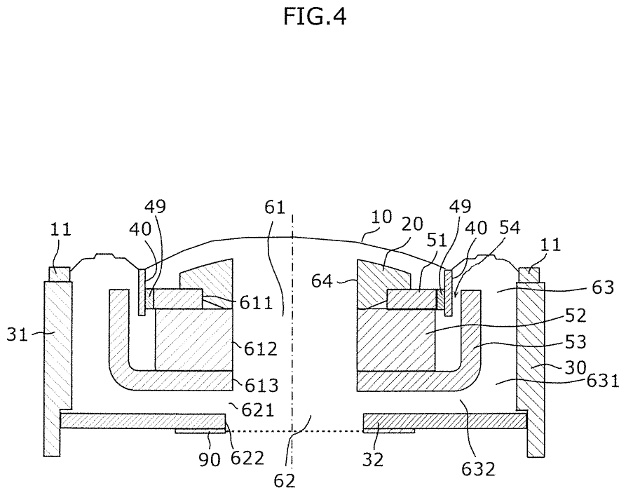

FIG. 1 is a perspective view illustrating an appearance of the loudspeaker according to Embodiment 1. FIG. 2 is an exploded perspective view illustrating the loudspeaker according to Embodiment 1. FIG. 3 is a sectional view of the loudspeaker in FIG. 1 taken along line III-III. FIG. 4 is a sectional view of the loudspeaker in FIG. 1 taken along line IV-IV.

As illustrated in FIGS. 1 to 4, loudspeaker 1 includes vibration plate 10, housing 30, voice coil 40, magnetic circuit 50, and magnetic fluid 49. In the case of the present embodiment, loudspeaker 1 further includes stopper 20 and net 90. In loudspeaker 1, the side of loudspeaker 1 from which sounds are output is defined as a front surface side, and the side opposite thereto is defined as a rear surface side.

Vibration plate 10 is a member which vibrates by vibration of voice coil 40 fixed thereto to convert an audio signal input to voice coil 40 into a sound. In the case of the present embodiment, as the shape seen from the front surface side, vibration plate 10 has a central portion projected from the outer circumferential end toward the front surface side.

Edge 12 softer than vibration plate 10 is attached to the outer circumference of vibration plate 10. Edge 12 allows the vibration of vibration plate 10. In the case where any signal is not input to voice coil 40, edge 12 neutrally maintains vibration plate 10.

Edge 12 includes outer circumferential ring 11 at the outer circumferential end of edge 12. Outer circumferential ring 11 is fixed to housing 30, and thus vibration plate 10 is held by housing 30 through edge 12. In this specification and Claims, the vibration plate indicates an inner portion with respect to the annular portion held by the housing. Accordingly, vibration plate 10 also includes edge 12 in the case of the present embodiment.

Housing 30 is a structural base member of loudspeaker 1 and is in a shape of a bottomed tube. Housing 30 holds vibration plate 10 at the end of the front surface side, and accommodates stopper 20, voice coil 40, magnetic circuit 50, and magnetic fluid 49 inside thereof. Housing 30 includes second flow path 62 in the form of a hole which extends first flow path 61 in the form of a hole to the outside of the bottom surface of housing 30, and third flow path 63 through which air passes from the side of vibration plate 10 to second flow path 62. Housing 30 can be formed of any material. Examples thereof include metals and resins.

In the case of the present embodiment, housing 30 includes cylindrical side wall member 31, bottom plate 32 attached to one end of side wall member 31, and spacer 33 disposed between bottom plate 32 and magnetic circuit 50. Side wall member 31, bottom plate 32, and spacer 33 are separate members.

Side wall member 31 includes side wall flow path portion 631, which is part of third flow path 63. The cross-section of a surface of side wall flow path portion 631 vertical to the tube axis of the voice coil has a shape of a sector. Side wall flow path portion 631 is open toward the side of magnetic circuit 50, and the outer circumferential surface of magnetic circuit 50 is disposed so as to cover the open portion of side wall flow path portion 631 in the form of a groove. In other words, side wall flow path portion 631 is formed as a hole defined by side wall member 31 and the outer circumferential surface of magnetic circuit 50.

Bottom plate 32 includes bottom plate path 622 in the form of a circular plate in its center, bottom plate path 622 being part of second flow path 62. Bottom plate 32 is connected to input terminal 41 of voice coil 40 to function as a board terminal including a terminal connected to an external wiring for obtaining an external electric signal. Bottom plate 32 is disposed on spacer 33 on the side opposite to the side where yoke 53 is disposed. Spacer 33 is formed of a resin material, and electrically insulates bottom plate 32 from magnetic circuit 50. At least one of bottom plate 32 and spacer 33 may be integrally formed with side wall member 31.

Net 90 covers bottom plate path 622 of bottom plate 32. Net 90 is disposed on the side of bottom plate 32 opposite to the side where spacer 33 is disposed.

Spacer 33 is a member for forming a space between yoke 53 and bottom plate 32 to form side flow path portion 632 of third flow path 63 (see FIG. 4), and includes slit 331 (see FIG. 2). In the case of the present embodiment, spacer 33 is divided into two with slit 331 interposed therebetween. Spacer 33 is disposed on the side of yoke 53 opposite to the side where magnet 52 is disposed. Spacer 33 includes spacer hole 621, which is part of second flow path 62, in the central portion thereof. Spacer hole 621 has a cross-sectional area smaller than that of bottom plate path 622. The end of side flow path portion 632 is connected to the lateral portion of second flow path 62 through spacer 33.

As above, side flow path portion 632, which is part of third flow path 63 disposed at the bottom of housing 30, is formed in the form of a hole by the bottom surface of yoke 53 in magnetic circuit 50, bottom plate 32 disposed facing the bottom surface of yoke 53, and spacer 33 divided by slit 331.

Net 90 is a member which includes a mesh and covers the opening end of the rear surface of second flow path 62 opposite to vibration plate 10, in other words, the outer side of bottom plate path 622. The sound pressure frequency properties of loudspeaker 1 can be varied by attaching net 90 having a different mesh size.

Magnetic circuit 50 is a circuit which generates steady state magnetic flux in magnetic gap 54, and is provided with first flow path 61 in the form of a through hole coaxial with the tube axis of voice coil 40. Magnetic circuit 50 includes plate 51, magnet 52, and yoke 53.

Plate 51 is a member formed of a magnetic body having a circular platy shape and having a through hole or plate path 611, which is part of first flow path 61, in the center of the magnetic body. One surface of plate 51 is fixed to one end surface of magnet 52 with an adhesive or the like, facing each other. The outer circumferential end of plate 51 is disposed on one side of magnetic gap 54.

Magnet 52 is a permanent magnet having a circular platy shape and a through hole or magnet path 612, which is part of first flow path 61, in the center of the magnet. The surface of magnet 52 on the side of vibration plate 10 has one of the north pole and the south pole while the surface thereof on the side of bottom plate 32 has the other of the north pole and the south pole. Plate 51 is fixed to the surface of magnet 52 on the side of vibration plate 10, and yoke 53 is fixed to the surface thereof on the side of bottom plate 32. Specifically, plate 51, magnet 52, and yoke 53 are fixed to each other with an adhesive. Plate 51, magnet 52, and yoke 53 do not always need to be fixed with an adhesive, and may be fixed using a fastening member such as a screw or a rivet.

Yoke 53 is a member which defines magnetic gap 54 with plate 51, and is in a shape of a bottomed tube. Yoke 53 is a member formed of a magnetic body having a through hole or yoke path 613, which is part of first flow path 61, in the center of the bottom thereof. The outer circumferential surface of yoke 53 is partially held by housing 30.

The cross-sectional area of magnet path 612 vertical to the tube axis of voice coil 40 is configured to be smaller than that of plate path 611 and that of yoke path 613.

Stopper 20 is a member which regulates the displacement of vibration plate 10 toward magnetic circuit 50 to prevent vibration plate 10 from approaching excessively close to plate 51. Stopper 20 is projected toward vibration plate 10 from plate 51, and has a shape along the shape of vibration plate 10. A gap is formed between the projected portion of stopper 20 and vibration plate 10. Stopper 20 includes a through hole or fourth flow path 64 which extends first flow path 61 to the side of vibration plate 10 and has a cross-sectional area larger than that of first flow path 61 vertical to the tube axis of voice coil 40. Stopper 20 is formed of a metal or a resin, for example.

Voice coil 40 is a coiled member produced by winding a metal wire material several times into loops (in a cylindrical shape). Voice coil 40 has input terminal 41 to which an audio signal is input. One end of voice coil 40 is inserted into magnetic gap 54 of magnetic circuit 50, and the other end thereof is fixed to vibration plate 10. Specifically, voice coil 40 is fixed to a site of vibration plate 10 on an inner side with respect to the outer circumferential end of vibration plate 10.

Voice coil 40 may be wound around a bobbin, or may be fixed to vibration plate 10 through a bobbin.

Magnetic fluid 49 is disposed between plate 51 of magnetic circuit 50 and voice coil 40 in magnetic gap 54. Magnetic fluid 49 is disposed from the surface of plate 51 on the outer circumference side to the surface of voice coil 40 on the inner circumference side. In other words, magnetic fluid 49 is disposed in the state where plate 51 and voice coil 40 are bridged. Magnetic fluid 49 is disposed across the entire outer circumference of plate 51 in an annular shape. In other words, magnetic fluid 49 is disposed across the entire inner circumference of voice coil 40 in an annular shape. The gap between voice coil 40 and plate 51 is sealed by magnetic fluid 49.

Magnetic fluid 49 is a magnetic colloid solution prepared by mixing ferromagnetic nanoparticles, such as iron oxide (Fe₃O₄), a dispersant covering the surfaces of the ferromagnetic nanoparticles, such as an organic acid, and a solvent made of a synthetic hydrocarbon oil such as poly-α-olefin.

Magnetic fluid 49 has a viscosity of more than 9 mPa·s and 500 mPa·s or less at a predetermined reference temperature (such as ambient temperature of 15 to 35° C.). The reference temperature may be 27° C., for example. Magnetic fluid 49 has a local minimum value of a viscosity of 9 mPa·s or more in the temperature range beyond the reference temperature. The viscosity of magnetic fluid 49 at the reference temperature is greater than the viscosity of magnetic fluid 49 in the temperature range beyond the reference temperature. Magnetic fluid 49 has a magnetic saturation density of 22 mT or more. The magnetic saturation density is also referred to as saturation magnetization.

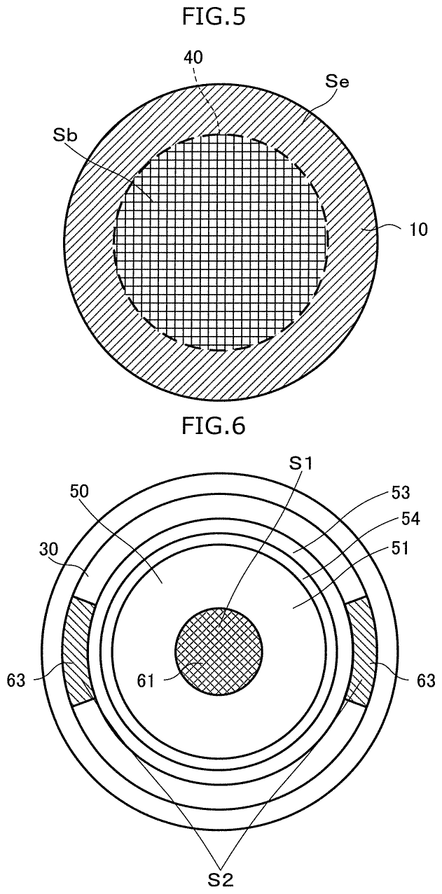

The relation between first flow path 61 and third flow path 63 will now be described. FIG. 5 is a diagram illustrating vibration plate 10 seen from the front surface side thereof. FIG. 6 is a diagram illustrating the loudspeaker seen from the front surface side thereof, where the vibration plate is removed.

With reference to FIG. 5, in the case where vibration plate 10 is seen in planar view, the inner area is defined as Sb, which is the area on an inner side with respect to voice coil 40 fixed to vibration plate 10, and the outer area is defined as Se, which is the area on an outer side with respect to voice coil 40. With reference to FIG. 6, a first area, which is the area of the opening of first flow path 61, is defined as S1. A second area, which is the area of the opening of third flow path 63, is defined as S2. Here, in the case of the present embodiment, loudspeaker 1 includes third flow path 63 in several places (two places in the present embodiment). For this reason, second area S2 is defined as the total sum of the areas of the openings of the several third flow paths 63.

In this case, loudspeaker 1 includes vibration plate 10, voice coil 40, first flow path 61, and third flow path 63 where the expression represented by Sb/S1=Se/S2 is satisfied. In other words, the proportion of second area S2 to first area S1 of loudspeaker 1 matches with the proportion of outer area Se to inner area Sb (S2/S1=Se/Sb).

It should be noted that FIGS. 5 and 6 are diagrams schematically illustrating the members and the like, where the proportion is not precisely illustrated.

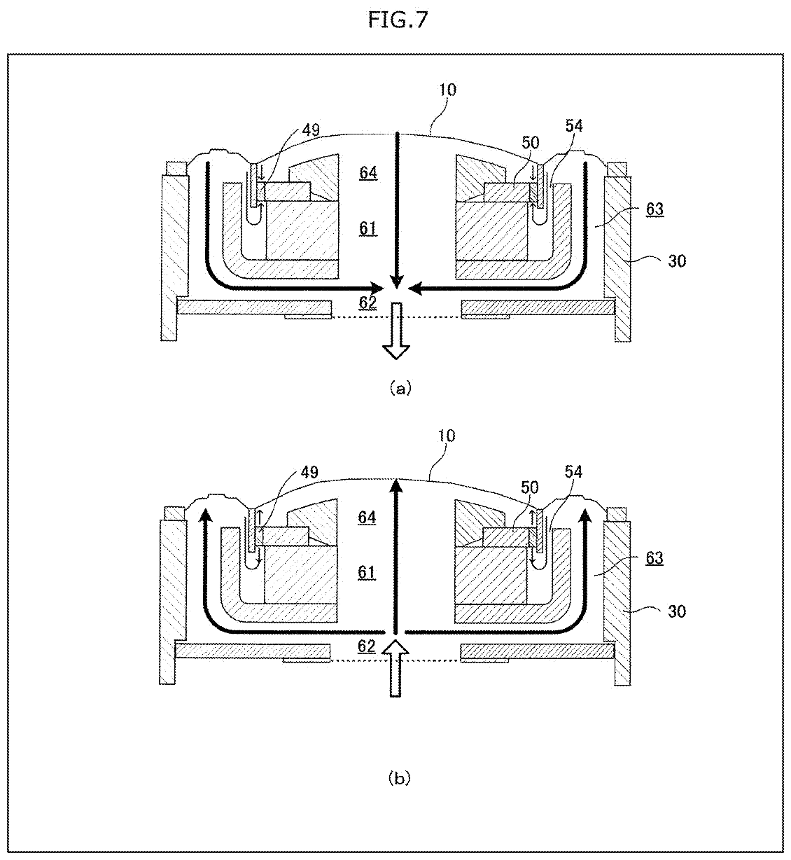

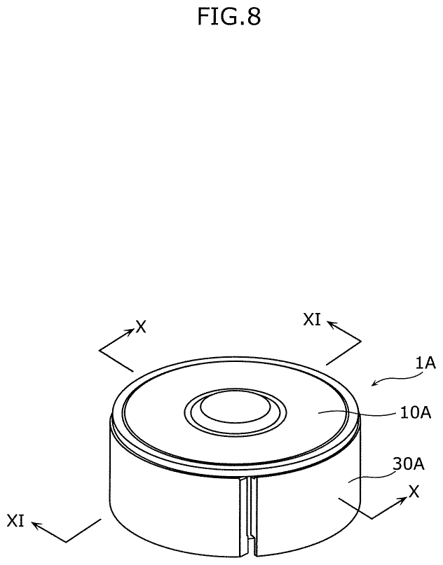

According to loudspeaker 1 according to the present embodiment, in the case where vibration plate 10 displaces in a direction approaching magnetic circuit 50 as illustrated in (a) of FIG. 7, most of the wind pressure corresponding to the inner area passes through first flow path 61, and merges with most of the wind pressure corresponding to the outer area at second flow path 62. The merged wind pressure is then discharged to the outside of housing 30. In contrast, the residual wind pressure corresponding to the inner area is applied to magnetic fluid 49 from the side of vibration plate 10, and the residual wind pressure corresponding to the outer area passes through magnetic gap 54 and is applied to magnetic fluid 49 from the side opposite to vibration plate 10. In loudspeaker 1 according to the present embodiment where the relation among the outer area, the inner area, the first area, and the second area is thus set, the two pressures applied to the magnetic fluid are substantially identical and are applied from the opposite directions. For this reason, the two pressures are cancelled. Accordingly, scattering of magnetic fluid 49 caused by the wind pressure can be prevented.

Similarly, in the case where vibration plate 10 displaces in a direction away from magnetic circuit 50 as illustrated in (b) of FIG. 7, the air is sucked from second flow path 62 and the wind pressures are applied in a direction in which magnetic fluid 49 is pulled. Also in this case, the two pressures are substantially identical and are applied in the opposite directions, thereby preventing the scattering of magnetic fluid 49.

As described above, even after long-term use of loudspeaker 1, magnetic fluid 49 remains inside magnetic gap 54 to continuously stabilize the vibration of voice coil 40, therefore maintaining properties of the loudspeaker such as sound pressure frequency properties for a long time.

### Embodiment 2

The loudspeaker according to Embodiment 2 will now be described. The loudspeaker according to Embodiment 2 is a loudspeaker having a magnetic circuit of an external magnet type.

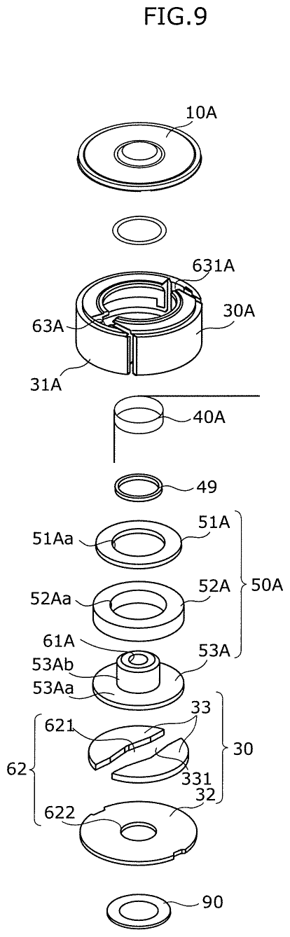

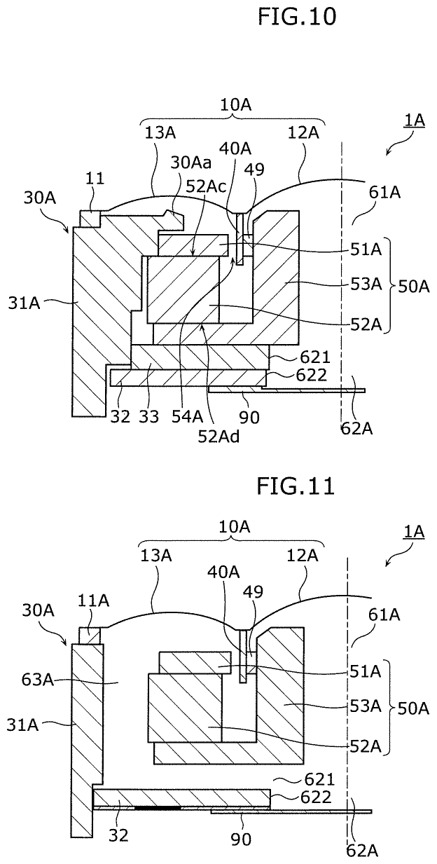

FIG. 8 is a perspective view illustrating an appearance of the loudspeaker according to Embodiment 2. FIG. 9 is an exploded perspective view illustrating the loudspeaker according to Embodiment 2. FIG. 10 is a sectional view illustrating the loudspeaker in FIG. 8 taken along line X-X. FIG. 11 is a sectional view illustrating the loudspeaker in FIG. 8 taken along line XI-XI. FIGS. 10 and 11 are sectional views each illustrating the left-half configuration of the loudspeaker with respect to the central axis.

As illustrated in FIGS. 8 to 11, loudspeaker 1A includes vibration plate 10A, housing 30A, voice coil 40A, plate 51A, magnet 52A, yoke 53A, and magnetic fluid 49. In other words, plate 51A, magnet 52A, yoke 53A, and magnetic fluid 49 form a magnetic circuit of an external magnet type. Loudspeaker 1A may further include bottom plate 32, spacer 33, and net 90. Bottom plate 32, spacer 33, and net 90 are the same as those in the configuration of loudspeaker 1 according to Embodiment 1, and therefore the description thereof will be omitted.

Vibration plate 10A is in the form of a thin circular plate. Similarly to vibration plate 10 according to Embodiment 1, vibration plate 10A includes vibration plate body 12A and vibration plate edge 13A. Unlike Embodiment 1, in vibration plate 10A according to Embodiment 2, the width of vibration plate edge 13A in the diameter direction is identical with the width of vibration plate body 12A in the diameter direction. The configuration of vibration plate 10A other than this is the same as that of vibration plate 10, and the description thereof will be omitted.

Housing 30A has the same configuration as that of housing 30 according to Embodiment 1. Housing 30A includes side wall member 31A, third flow path 63A, and side wall flow path portion 631A, which correspond to side wall member 31, third flow path 63, and side wall flow path portion 631 of housing 30, respectively. As illustrated in FIG. 10, unlike housing 30 according to Embodiment 1, housing 30A has protrusion 30Aa projected toward the projecting direction (i.e., front side) of vibration plate edge 13A in vibration plate 10A. Protrusion 30Aa may be projected to the front side from outer circumferential ring 11, for example. Protrusion 30Aa is a member for preventing vibration plate 10A from excessively approaching plate 51A, and has the same function as that of stopper 20 in Embodiment 1. In other words, protrusion 30Aa can prevent contact of the inner surface of vibration plate 10A with magnetic fluid 49, which is caused as a result of vibration plate 10A approaching plate 51A. Thus, protrusion 30Aa can prevent the scattering of magnetic fluid 49 from the space between voice coil 40A and yoke 53A, which is caused by contact of the inner surface of vibration plate 10A with magnetic fluid 49.

Magnetic circuit 50A is a circuit which generates steady state magnetic flux in magnetic gap 54A, and includes first flow path 61A in the form of a through hole coaxial with the tube axis of voice coil 40A. Magnetic circuit 50A includes plate 51A, magnet 52A, and yoke 53A.

Plate 51A is a metal member having a shape of a circular plate and having through hole 51Aa formed in the center thereof.

Similarly to magnet 52 according to Embodiment 1, magnet 52A is a permanent magnet having a shape of a circular plate and having through hole 52Aa formed in the center thereof. Plate 51A is fixed to one end surface 52Ac of magnet 52A in the thickness direction (front and rear direction), and yoke 53A is fixed to end surface 52Ad opposite to end surface 52Ac. Usually, magnet 52A has end surface 52Ac as the south pole and end surface 52Ad as the north pole. It should be noted that the configuration is not limited to that described above, end surface 52Ac may be the south pole and end surface 52Ad may be the north pole. Magnet 52A is disposed coaxially with plate 51A. Magnet 52A may have an outer diameter larger than that of plate 51A. The inner diameter of through hole 52Aa of magnet 52A is larger than the inner diameter of through hole 51Aa of plate 51A. Plate 51A, magnet 52A, and yoke 53A are fixed to each other with an adhesive. Plate 51A, magnet 52A, and yoke 53A do not always need to be fixed with an adhesive, and may be fixed using a fastening member such as a screw or a rivet.

Yoke 53A includes circular plate portion 53Aa having a shape of a circular plate and having a through hole or first flow path 61A formed in the center thereof, and a cylindrical tube portion 53Ab erected from the inner circumferential edge of circular plate portion 53Aa on circular plate portion 53Aa. The surface of yoke 53A including tube portion 53Ab of circular plate portion 53Aa formed thereof is fixed to end surface 52Ad of magnet 52A. Tube portion 53Ab of yoke 53A is disposed inside through hole 52Aa of magnet 52A, passes through magnet 52A, and is not in contact with through hole 52Aa of magnet 52A. Magnet 52A is disposed so as to cover the outer side of tube portion 53Ab of yoke 53A, and a cylindrical space is formed between tube portion 53Ab and magnet 52A. Circular plate portion 53Aa of yoke 53A is disposed coaxially with magnet 52A. Tube portion 53Ab of yoke 53A extends so as to pass through through hole 51Aa of plate 51A. In other words, tube portion 53Ab has a facing portion facing an inner lateral surface of through hole 51Aa of plate 51A. Magnetic gap 54A is formed between tube portion 53Ab and plate 51A. Yoke 53A is formed of a magnetic body.

Tube portion 53Ab of yoke 53A is projected to the front side from plate 51A. Thereby, tube portion 53Ab has the same function as that of stopper 20 according to Embodiment 1. In other words, tube portion 53Ab can prevent contact of the inner surface of vibration plate 10A with magnetic fluid 60, which is caused as a result of vibration plate 10A approaching plate 51A. Such a configuration can prevent the scattering of magnetic fluid 49 from the space between voice coil 40A and yoke 53A, which is caused by contact of the inner surface of vibration plate 10A with magnetic fluid 49.

Thus, plate 51A, magnet 52A, and yoke 53A form magnetic circuit 50A of an external magnet type. Since magnetic circuit 50A is of an external magnet type, yoke 53A can be disposed at the inner circumference of magnet 52A. For this reason, magnetic circuit 50A can be configured to be smaller than that of an internal magnet type.

Similarly to voice coil 40 according to Embodiment 1, voice coil 40A is a coiled member produced by winding a metal wire material several times into loops (in a cylindrical shape). Voice coil 40A has an input terminal to which an electric signal is input. Voice coil 40A is fixed to vibration plate 10A. Specifically, voice coil 40A is fixed to a site of vibration plate 10A on an inner side with respect to the outer circumferential end of vibration plate 10A. Voice coil 40A is disposed inside magnetic gap 54A of magnetic circuit 50A.

Magnetic fluid 49 is disposed between the portion of magnetic circuit 50A facing tube portion 53Ab and voice coil 40A. Magnetic fluid 49 is disposed across the surface of tube portion 53Ab on the outer circumference side and the surface of voice coil 40A on the inner circumference side. In other words, magnetic fluid 49 is disposed in the state where tube portion 53Ab and voice coil 40A are bridged. Magnetic fluid 49 is disposed across the entire outer circumference of tube portion 53Ab in an annular shape. In other words, magnetic fluid 49 is disposed across the entire inner circumference of voice coil 40A in an annular shape. Magnetic fluid 49 is formed of the same material as that in Embodiment 1.

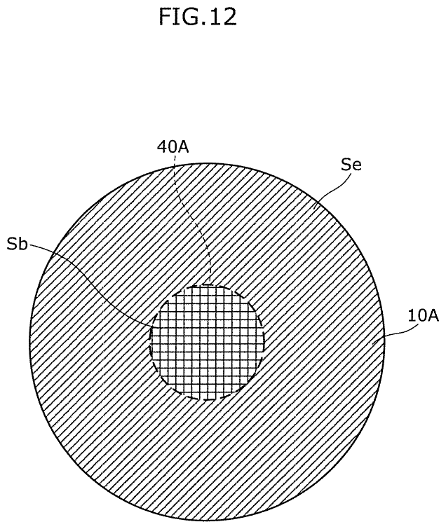

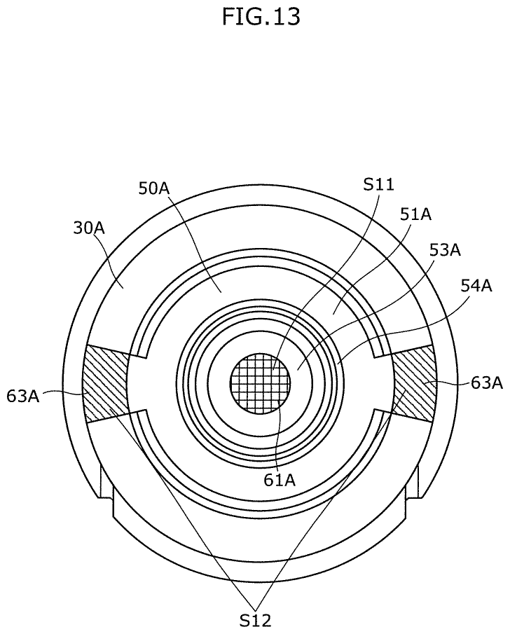

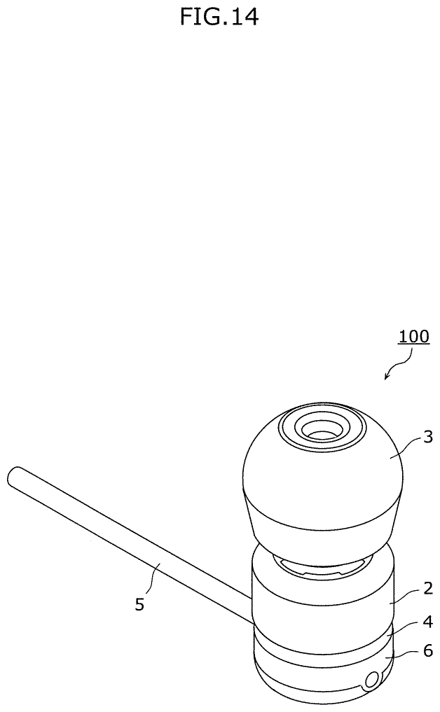

The relation between first flow path 61A and third flow path 63A will now be described. FIG. 12 is a diagram illustrating the vibration plate according to Embodiment 2 from the front surface side. FIG. 13 is a diagram illustrating the loudspeaker from the front surface side where the vibration plate according to Embodiment 2 is removed.

With reference to FIG. 12, in the case where vibration plate 10A is seen in planar view, the inner area, which is the area on the inner side with respect to voice coil 40A fixed to vibration plate 10A, is defined as Sb, and the outer area, which is the area on the outer side with respect thereto, is defined as Se. With reference to FIG. 13, a first area, which is the area of the opening of first flow path 61A, is defined as S11. A second area, which is the area of the opening of third flow path 63A, is defined as S12. Here, in the case of the present embodiment, loudspeaker 1A includes third flow path 63A in several places (two places in the present embodiment). For this reason, second area S12 is defined as the total sum of the areas of the openings of the several third flow paths 63A.

In this case, similarly to loudspeaker 1 according to Embodiment 1, loudspeaker 1A includes vibration plate 10A, voice coil 40A, first flow path 61A, and third flow path 63A which satisfy the relation represented by an expression Sb/S11=Se/S12. In other words, the proportion of second area S12 to first area S11 of loudspeaker 1A matches with the proportion of outer area Se to inner area Sb (S12/S11=Se/Sb).

It should be noted that FIGS. 12 and 13 are diagrams schematically illustrating the members and the like, where the proportion is not precisely illustrated.

As described above, loudspeaker 1A including magnetic circuit 50A of an external magnet type according to Embodiment 2 can also have the same effect as that of loudspeaker 1 including magnetic circuit 50 of an internal magnet type according to Embodiment 1.

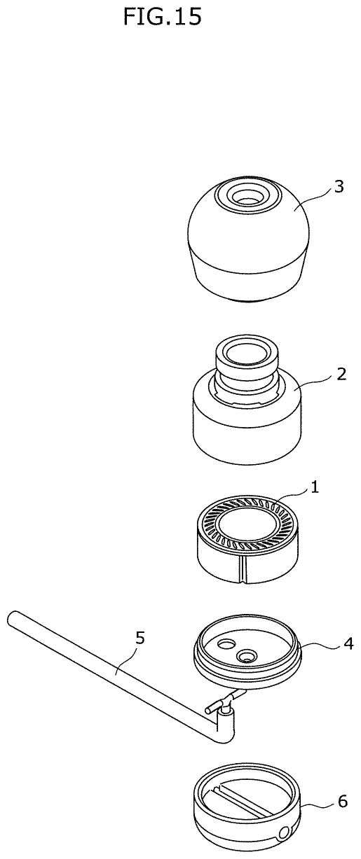

FIG. 14 is a perspective view illustrating an appearance of an earphone including the loudspeaker according to any one of Embodiments 1 and 2. FIG. 15 is an exploded perspective view illustrating the earphone.

As illustrated in FIGS. 14 and 15, earphone 100 includes loudspeaker 1, port 2, ear chip 3, box 4, cable 5, and back cover 6. Earphone 100 is one of headphones of an inner ear type. Loudspeaker 1A may be used instead of loudspeaker 1.

Loudspeaker 1 has the configuration as described in the embodiment above.

Port 2 is an approximately cylindrical member which accommodates loudspeaker 1 inside thereof.

Ear chip 3 is a member connected to the distal end of port 2, and is a member for disposing earphone 100 inside the human ear canal.

Box 4 is a member which covers the opening opposite to the side of port 2 where ear chip 3 is disposed.

Cable 5 passes through box 4 to be connected to bottom plate 32 of loudspeaker 1, and is a member for inputting an electric signal to loudspeaker 1.

Back cover 6 is a member which covers the portion where cable 5 passes through box 4.

In earphone 100 thus configured, a sound output from loudspeaker 1 according to the electric signal input to cable 5 is output from port 2 and ear chip 3. For this reason, in the case where ear chip 3 is mounted on the human ear canal, the person can hear the sound from earphone 100.

Although an example in which loudspeaker 1 is used as one of headphones of an inner ear type has been described in the usage example above, loudspeaker 1 may be used in one of headphones of an overhead type or may be used as a loudspeaker of a mobile terminal. Furthermore, loudspeaker 1 may also be used in hearing aids.

This disclosure is not limited to the embodiments above. For example, other embodiments implemented with any combination of the components described in this specification or components excluding some of the components described herein may be included in embodiments according to this disclosure. Moreover, modifications obtained by modifying the embodiments above in various ways conceived by persons skilled in the art without departing the gist of this disclosure, namely, the meanings of the expressions described in the scope of claims are also included in this disclosure.

For example, although the vibration plate of a dome type has been exemplified, the vibration plate may be a flat plate or a plate having a cone shape. The shape of the vibration plate seen in planar view may be not only a circular shape but also an oval shape or a rectangular shape.

In the case where the magnetic circuit is of an external magnet type, the first flow path may be disposed in the center pole of the yoke. In this case, the magnetic fluid is filled into the space between the center pole and the voice coil.

Although the loudspeaker including only one first flow path has been exemplified, the loudspeaker may include several first flow paths. The loudspeaker may include only one third flow path.

Although the side wall member, the bottom plate, the spacer, and the yoke are separate members in the exemplified loudspeaker above, the side wall may be integrally formed with the bottom plate. The spacer may be integrally formed with the bottom plate. Alternatively, the spacer may be integrally formed with the yoke.

Although the through holes of the members forming first flow path 61 and second flow path 62 have a constant cross-sectional area to form a straight hole in the description above, the opening ends of first flow path 61 and second flow path 62 may be tapered. However, the opening ends desirably have a tapered shape such that the distortion output from the vibration plate does not change. Preferably, the areas of the openings of first flow path 61 and second flow path 62 on the vibration plate side (plate 51 or stopper 20) are equal to those of the openings thereof on the rear surface side (yoke 53 or bottom plate 32 of housing 30).

### INDUSTRIAL APPLICABILITY

This disclosure is useful as a loudspeaker which can stably maintain the output sound pressure.

### REFERENCE SIGNS LIST

1 loudspeaker

2 port

3 ear chip

4 box

5 cable

6 back cover

10 vibration plate

11 outer circumferential ring

12 edge

20 stopper

30, 30A housing

30Aa protrusion

31, 31A side wall member

32 bottom plate

33 spacer

40, 40A voice coil

41 input terminal

49 magnetic fluid

50, 50A magnetic circuit

51, 51A plate

51Aa through hole

52, 52A magnet

52Aa through hole

52Ac, 52Ad end surface

53, 53A yoke

53Aa circular plate portion

53Ab tube portion

54, 54A magnetic gap

61, 61A first flow path

62 second flow path

63, 63A third flow path

64 fourth flow path

90 net

S1 first area

S2 second area

100 earphones

331 slit

611 plate path

612 magnet path

613 yoke path

621 spacer hole

622 bottom plate path

631, 631A side wall flow path portion

632 side flow path portion

1. A loudspeaker, comprising:
a magnetic circuit;
a yoke coil having one end disposed inside a magnetic gap formed in the magnetic circuit;
vibration plate to which the other end of the voice coil is fixed;
a housing which is in a shape of a bottomed tube, accommodates fie magnetic circuit, and holds the vibration plate; and
a magnetic fluid disposed between the magnetic circuit and the voice coil inside the magnetic gap,
wherein the magnetic circuit includes a first flow path disposed on an inner side with respect to the voice coil to pass from a vibration plate side of the magnetic circuit to a rear surface of the magnetic circuit, air passing through the first flow path,
the housing includes:
a second flow path which extends the first flow path to an outer side of a bottom surface of the housing; and
a third flow path disposed on an outer side with respect to the voice coil to pass from the vibration plate side to the second flow path, and
a proportion of a second area to a first area matches with a proportion of an outer area to an inner area, where the first area is an area of an opening of the first flow path and the second area is an area of an opening of the third flow path when seen from a tube axis direction of the voice coil, and the inner area is an area of the vibration plate corresponding to the inner side with respect to the voice coil and the outer area is an area of the vibration plate corresponding to the outer side with respect to the voice coil when seen from the tube axis direction of the voice coil.

2. The loudspeaker according to claim 1,
wherein the housing is in a shape of a bottomed cylinder, and
the third flow path includes a side wall flow path portion disposed in a side wall of the housing and having a cross-section in a shape of a sector.

3. The loudspeaker according to claim 1,
wherein the side wall flow path portion, which is disposed in the side wall of the housing as part of the third flow path, is formed of a groove formed in the housing facing a side of the magnetic circuit, and an outer circumferential surface of the magnetic circuit which covers the groove.

4. The loudspeaker according to claim 1,
wherein the housing includes a side wall member which is tubular, a bottom plate disposed at one end of the side wall member, and a spacer disposed between the bottom plate and the magnetic circuit, and
a side flow path portion, which is disposed at a bottom of the housing as part of the third flow path, is formed of a bottom surface of the magnetic circuit, the bottom plate disposed facing the bottom surface, and a slit disposed in the spacer.

5. The loudspeaker according to claim 1, comprising:
a stopper which is attached to the magnetic circuit on the vibration plate side of the magnetic circuit to regulate displacement of the vibration plate toward the magnetic circuit,
wherein the stopper includes a fourth flow path which extends the first flow path to the vibration plate side, and has an opening having an area larger than the first area of the first flow path.

6. The loudspeaker according to claim 1,
wherein the magnetic circuit includes:
a magnet having a magnet path which is part of the first flow path;
a plate having a plate path which is part of the first flow path; and
a yoke having a yoke path which is part of the first flow path, and
a cross-sectional area of the Limpet path is smaller than a cross-sectional area of the plate path and a cross-sectional area of the yoke path.

7. The loudspeaker according to claim 1, comprising:
a net which covers an opening end of a rear surface of the second flow path opposite to the vibration plate with respect to the housing.

8. An earphone, comprising the loudspeaker according to claim 1.
